(19) United States
(12) Patent Application Publication
(10) Pub. No.: US 2011/0219637 A1
(43) Pub. Date: Sep. 15, 2011

(54) DRUM DRYER WITH HEAT RECOVERY SWITCHING FABRIC

(76) Inventor: Tai-Her YANG, Dzan-Hwa (TW)

(21) Appl. No.: 12/722,613

(22) Filed: Mar. 12, 2010

(51) Int. Cl. F26B 11/02

(52) U.S. Cl. 34/132

(57) ABSTRACT

The present invention aims at the drum dryer drying the rolling clothes by the electric heating thermal energy, and a heat exchanging unit with heat recovery function is further installed between the room temperature air flow and the discharged hot air, for preheating the intake air flow by the thermal energy of the discharged hot air through the heat exchanging unit, to reduce the thermal energy loss.

### BACKGROUND OF THE INVENTION

(a) Field of the Invention

A drum dryer equipped with a heat exchanging unit, for holding the air flow intake flowpath and the flowpath of the hot air discharged from the drum, has the features of energy saving through preheating the air flow from the intake flowpath by the thermal energy of the hot air.

(b) Description of the Prior Art

For the conventional rolling drying device, such as the drum dryer, the intake air flow is heated by the electric heating device, and then enters the drum room to dry the clothes, and the hot air is directly discharged during the operational period, causing the thermal energy waste.

### SUMMARY OF THE INVENTION

The present invention aims at the drum dryer drying the rolling clothes by the electric heating thermal energy, and a heat exchanging unit with heat recovery function is further installed between the room temperature air flow and the discharged hot air, for preheating the intake air flow by the thermal energy of the discharged hot air through the heat exchanging unit, to reduce the thermal energy loss.

### BRIEF DESCRIPTION OF THE DRAWINGS

FIG. 1 is a schematic view showing the main structure of the embodiment, according to the present invention.

### DESCRIPTION OF MAIN COMPONENT SYMBOLS

(101): Air inlet port

(102): Heat exchanging unit

(103): Electric heating device

(104): Drum

(105): Drum drive motor set

(106): Electric fluid pump set

(1061): Fan motor

(1062): Fan

(107): Electronic control unit

(108): External operation interface

(109): Air exhaust port

### DETAILED DESCRIPTION OF THE PREFERRED EMBODIMENTS

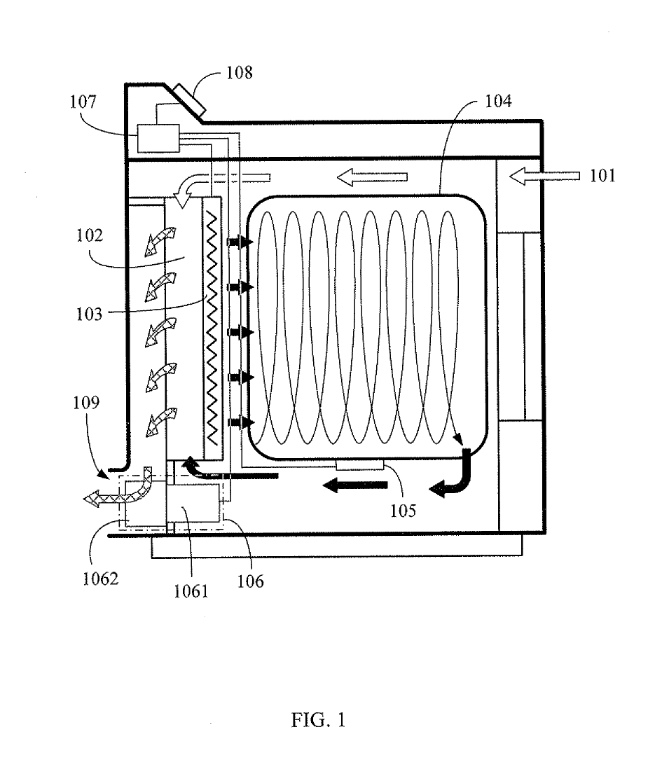

A drum dryer equipped with a heat exchanging unit, for commonly passing the air flow intake flowpath and the flowpath of the hot air discharged from the drum, has the features of preheating the air flow from the intake flowpath by the thermal energy of the hot air; FIG. 1 is a schematic view showing the main structure of the embodiment, according to the present invention; as shown in FIG. 1, except for the case, the power line, and the drum unit driven by the electric motor, the main components including:

air inlet port (101): by way of pumping by an electric fluid pump set (106), the external room temperature air flow attracted to inflow from the air inlet port (101), through a heat exchanging unit (102) and an electric heating device (103), and then into a drum (104);

heat exchanging unit (102): equipped with the intake flowpath for passing through the external room temperature air flow, and the hot current flowpath for passing through the discharged hot air, in which a good thermal conductive structure is installed between the intake flowpath and the hot current flowpath for separating the both, thus the thermal energy of the hot air preheats the air flow in the intake flowpath;

electric heating device (103): related to an electric heating device heated by the electric energy, which is controlled by an electronic control unit (107) over the heating temperature and the ON/OFF operation, to heat the intake air flow into the hot air;

drum (104): driven by a drum drive motor set (105) constituted by the drum drive motor and the transmission, to operate at determined rotary speed and direction, in which the drum (104) has hot air inlet and exhaust port, and the clothes or articles to be dried are put within the drum, and rolled through the driving by the drum drive motor set (105) to be dried by the hot air;

drum drive motor set (105): controlled by the electronic control unit (107) through the electric motor thereof, and driving the drum (104) through the transmission for revolution at preset rotary speed and direction;

electric fluid pump set (106): driving a fan (1062) through an electrified fan motor (1061) to produce flow kinetic energy of air flow, to make the external room temperature air flow enter the heat exchanging unit (102), pass through the room temperature fluid outlet of the heat exchanging unit (102) to further pass through and be heated by the electric heating device (103), and then reenter the drum, and to make the hot air at the outlet enter the hot air inlet of the heat exchanging unit (102), and then be discharged from an air exhaust port (109) at the hot current flowpath of the heat exchanging unit (102);

electronic control unit (107): constituted by the electromechanical component, or the solid state electronic component, and/or the microprocessor and operation software, for receiving the electric energy from the power supply and being set and controlled by an external operation interface (108), to control the operations of the electric heating device (103), the drum drive motor set (105), and the electric fluid pump set (106); and

external operation interface (108): constituted by the electromechanical component, or the solid state electronic component, and/or the microprocessor and operation software, for receiving manual input to control the operation of the electronic control unit (107).

By way of the above devices, when the operator turns on the external operation interface (108) for operation, the electronic control unit (107) starts the electric fluid pump set (106), the electric heating device (103), and the drum drive motor set (105), at this time, the room temperature air flow enters the intake flowpath of the heat exchanging unit (102) through the air inlet port (101), the room temperature air flow passes through the heat exchanging unit (102) for heat exchanging with the discharged hot air, and then is discharged by the outlet at the intake flowpath of the heat exchanging unit (102) for further being heated into hot air by the electric heating device (103), and then reenters the drum (104) driven by the drum drive motor set (105) to dry the clothes, and then flows into the inlet at the hot current flowpath of the heat exchanging unit (102) from the air exhaust port of the drum (104) to release the heat to the follow-up intake air flow entering the intake flowpath of the exchanging device from the air inlet port through the heat exchanging unit (102) before being discharged from the air exhaust port (109).

1. A drum dryer with heat recovery switching fabric, which is equipped with a heat exchanging unit, for commonly pass the air flow intake flowpath and the flowpath of the hot air discharged from the drum, in which the drum dryer has the features of preheating the air flow from the intake flowpath by the thermal energy of the hot air; except for the case, the power line, and the drum unit driven by the electric motor, the main components including:
air inlet port (101): by way of pumping by an electric fluid pump set (106), the external room temperature air flow attracted to inflow from the air inlet port (101), through a heat exchanging unit (102) and an electric heating device (103), and then into a drum (104);
heat exchanging unit (102): equipped with the intake flowpath for passing through the external room temperature air flow, and the hot current flowpath for passing through the discharged hot air, in which a good thermal conductive structure is installed between the intake flowpath and the hot current flowpath for separating the both, thus the thermal energy of the hot air preheats the air flow in the intake flowpath;
electric heating device (103): related to an electric heating device heated by the electric energy, which is controlled by an electronic control unit (107) over the heating temperature and the ON/OFF operation, to heat the intake air flow into the hot air;
drum (104): driven by a drum drive motor set (105) constituted by the drum drive motor and the transmission, to operate at determined rotary speed and direction, in which the drum (104) has hot air inlet and exhaust port, and the clothes or articles to be dried are put within the drum, and rolled through the driving by the drum drive motor set (105) to be dried by the hot air;
drum drive motor set (105): controlled by the electronic control unit (107) through the electric motor thereof, and driving the drum (104) through the transmission for revolution at preset rotary speed and direction;
electric fluid pump set (106): driving a fan (1062) through an electrified fan motor (1061) to produce flow kinetic energy of air flow, to make the external room temperature air flow enter the heat exchanging unit (102), pass through the room temperature fluid outlet of the heat exchanging unit (102) to further pass through and be heated by the electric heating device (103), and then reenter the drum, and to make the hot air at the outlet enter the hot air inlet of the heat exchanging unit (102), and then be discharged from an air exhaust port (109) at the hot current flowpath of the heat exchanging unit (102);
electronic control unit (107): constituted by the electromechanical component, or the solid state electronic component, and/or the microprocessor and operation software, for receiving the electric energy from the power supply and being set and controlled by an external operation interface (108), to control the operations of the electric heating device (103), the drum drive motor set (105), and the electric fluid pump set (106); and
external operation interface (108): constituted by the electromechanical component, or the solid state electronic component, and/or the microprocessor and operation software, for receiving manual input to control the operation of the electronic control unit (107).
